(19) United States
(12) Patent Application Publication
(10) Pub. No.: US 2013/0161522 A1
(43) Pub. Date: Jun. 27, 2013

(54) SCINTILLATOR PANEL, RADIATION DETECTION APPARATUS, AND RADIATION DETECTION SYSTEM INCLUDING THE SAME

(71) Applicant: CANON KABUSHIKI KAISHA, Tokyo (JP)

(72) Inventors: Yohei Ishida, Honjo-shi (JP); Satoshi Okada, Tokyo (JP); Akiya Nakayama, Kawasaki-shi (JP)

(73) Assignee: CANON KABUSHIKI KAISHA, Tokyo (JP)

(21) Appl. No.: 13/720,707

(22) Filed: Dec. 19, 2012

(30) Foreign Application Priority Data
Dec. 26, 2011 (JP) 2011-283301

(51) Int. Cl. G01T 1/20

(52) U.S. Cl. CPC G01T 1/2006; G01T 1/20
USPC 250/366; 250/483.1

(57) ABSTRACT

A scintillator panel includes a scintillator that converts radiation into light of a wavelength detectable by photoelectric conversion elements. The scintillator panel has a surface including a plurality of protrusions adjacent to each other. The adjacent protrusions are arranged at a pitch below a diffraction limit for the wavelength of the light emitted by the scintillator. Thus, a scintillator panel with improved availability of light emitted by a scintillator is provided.

### BACKGROUND OF THE INVENTION

1. Field of the Invention

The present invention relates to scintillator panels, radiation detection apparatuses, and radiation detection systems including the radiation detection apparatuses.

2. Description of the Related Art

Conventionally, a type of radiation detection apparatus includes a sensor panel and a scintillator panel disposed thereon. The sensor panel has a plurality of photoelectric conversion elements arranged in a matrix of rows and columns. The scintillator panel has a scintillator layer that converts radiation into light of a wavelength detectable by the photoelectric conversion elements. U.S. Patent Application Publication No. 2004/017495 discloses a radiation detection apparatus with improved optical coupling between a scintillator and photoelectric conversion elements. This radiation detection apparatus includes a sensor panel having a light-receiving surface with protrusions and recesses for improved optical absorption. A void and an antireflection layer are provided between the sensor panel and the scintillator layer in the above order from the sensor panel side.

The radiation detection apparatus described in the related art has the potential of causing light reflection between the antireflection layer and the void if there is a difference in refractive index between the antireflection layer and the void. These reflections cause scattering and unnecessarily decrease the intensity of light emitted by the scintillator, and thus the intensity (amount) of light that reaches the sensor panel is low. Thus, the light emitted by the scintillator is available at the sensor panel in low amounts, which is detrimental to image quality.

### SUMMARY OF THE INVENTION

According to an aspect of the present invention, a scintillator panel includes a scintillator that converts radiation into light of a wavelength detectable by photoelectric conversion elements. The scintillator panel has a surface including a plurality of protrusions adjacent to each other. The adjacent protrusions are arranged at a pitch below a diffraction limit for the wavelength of the light emitted by the scintillator. According to another aspect of the present invention, a radiation detection apparatus includes a sensor panel including photoelectric conversion elements; a scintillator panel including a scintillator that converts radiation into light of a wavelength detectable by the photoelectric conversion elements; and a member having a different refractive index from a surface of the scintillator panel opposite the sensor panel. The scintillator is disposed on the sensor panel with the member between the surface and the photoelectric conversion elements. The surface includes a plurality of protrusions adjacent to each other. The adjacent protrusions are arranged at a pitch below a diffraction limit for the wavelength of the light emitted by the scintillator.

Advantageously, according to at least one embodiment of the present invention, a scintillator panel and a radiation detection apparatus with improved availability of light emitted by a scintillator are disclosed.

Further features of the present invention will become apparent from the following description of exemplary embodiments with reference to the attached drawings.

### BRIEF DESCRIPTION OF THE DRAWINGS

FIG. 1A is a schematic plan view of a radiation detection apparatus according to an embodiment of the present invention.

FIG. 1B is a schematic sectional view taken along line IB-IB in FIG. 1A.

FIG. 2 is a schematic sectional view of one pixel in the radiation detection apparatus.

FIG. 3A is a schematic plan view illustrating protrusions and recesses on a scintillator surface in the radiation detection apparatus.

FIG. 3B is a schematic sectional view taken along line IIIB-IIIB in FIG. 3A.

FIGS. 4A to 4C are schematic sectional views illustrating a process of manufacturing a scintillator panel.

FIGS. 5A to 5D are schematic sectional views illustrating a process of manufacturing a radiation detection apparatus.

FIG. 6A is a schematic plan view illustrating a radiation detection apparatus according to another embodiment of the present invention.

FIG. 6B is a schematic sectional view taken along line VIB-VIB in FIG. 6A.

FIG. 7 is a schematic view illustrating an example of a radiation detection system including a radiation detection apparatus according to another embodiment of the present invention.

### DESCRIPTION OF THE EMBODIMENTS

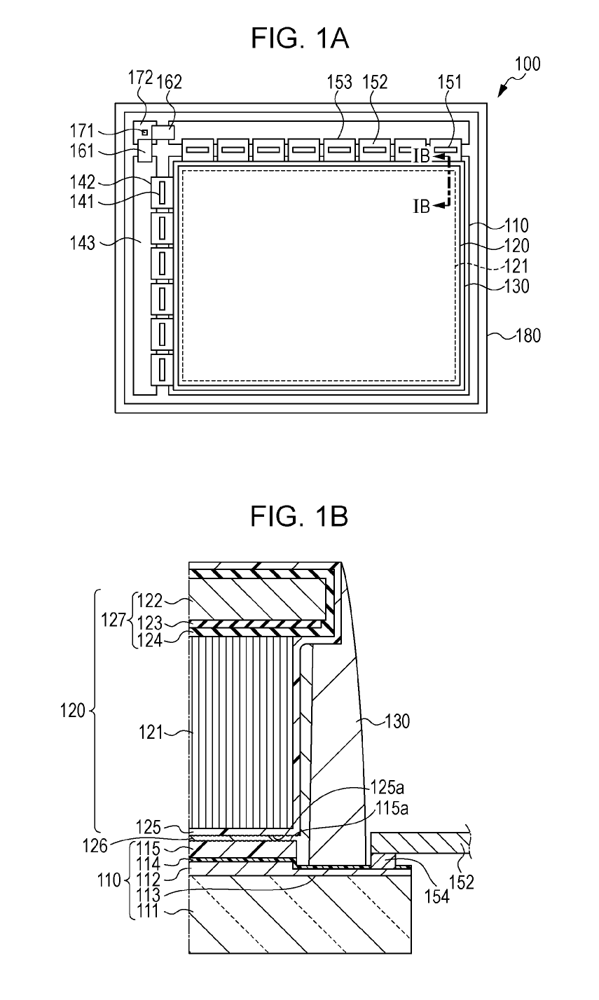

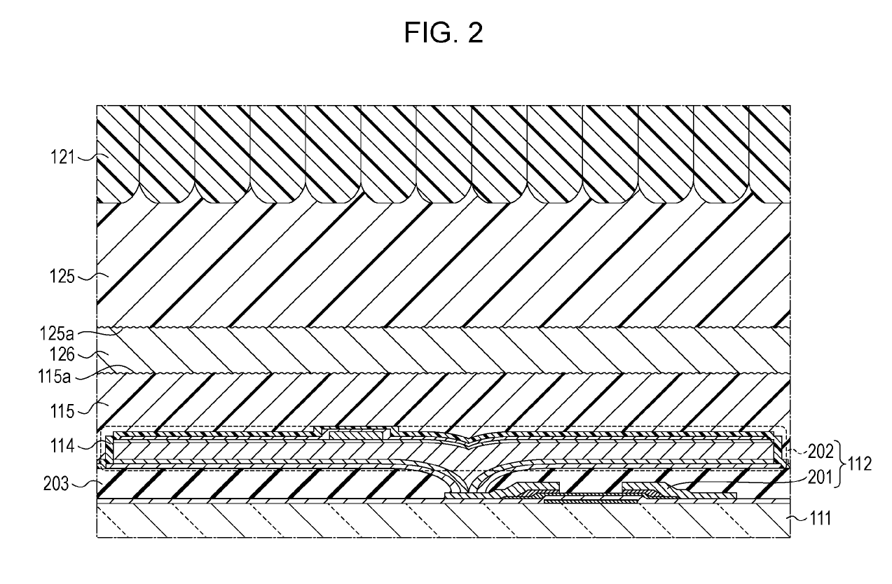

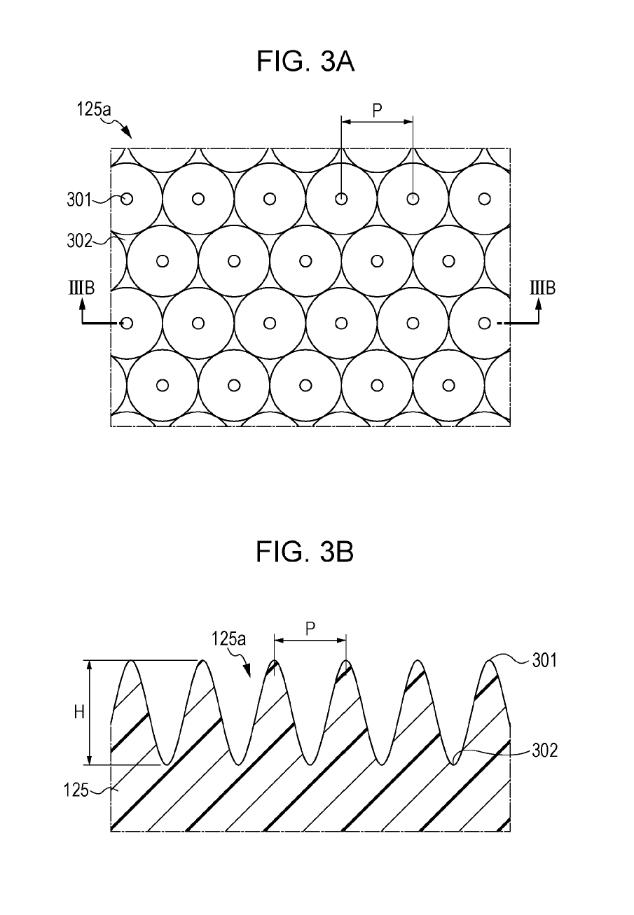

A radiation detection apparatus according to an embodiment of the present invention will now be described in detail with reference to FIGS. 1A, 1B, 2, 3A, and 3B. FIG. 1A is a schematic plan view of the radiation detection apparatus 100 according to this embodiment. FIG. 1B is a schematic sectional view taken along line IB-IB in FIG. 1A. FIG. 2 is a schematic sectional view showing one pixel in an enlarged view. FIG. 3A is a schematic plan view illustrating protrusions and recesses on a scintillator surface. FIG. 3B is a schematic sectional view taken along line IIIB-IIIB in FIG. 3A.

As shown in FIGS. 1A and 1B, the radiation detection apparatus 100 includes a housing 180 accommodating a sensor panel 110 and a scintillator panel 120. The sensor panel 110 includes a plurality of pixels 112 arranged in a matrix of rows and columns. The scintillator panel 120 includes a scintillator 121 disposed opposite the sensor panel 110. The pixels 112 include at least photoelectric conversion elements 202, described later. The width of the photoelectric conversion elements 202, which corresponds to the width of the pixels 112, can be 50 to 200 μm. The sensor panel 110 and the scintillator panel 120 are bonded together with at least a sealing part 130. The radiation detection apparatus 100 also includes drive flexible circuit boards 142 having drive circuits 141, a drive printed circuit board 143, signal-processing flexible circuit boards 152 having signal-processing circuits 151, and a signal-processing printed circuit board 153. The radiation detection apparatus 100 also includes a printed circuit board 172 having a control and power supply circuit 171. The drive printed circuit board 143 is connected to the printed circuit board 172 via a flexible circuit board 161. The signal-processing printed circuit board 153 is connected to the printed circuit board 172 via a flexible circuit board 162.

As shown in FIGS. 1B and 2, the scintillator panel 120 includes the scintillator 121, which converts radiation into light of the wavelength detectable by the photoelectric conversion elements 202. The scintillator panel 120 also includes a support 127 and a covering layer 125. The support 127 includes a substrate 122, a reflective layer 123, and an insulating layer 124. The scintillator 121, which converts radiation into light of the wavelength detectable by the photoelectric conversion elements 202, can be a columnar crystal scintillator or a granular scintillator. Examples of columnar crystal scintillators include alkali halide scintillators, such as cesium iodide (CsI), activated by addition of an activator such as thallium (Tl) (i.e., CsI:Tl). For example, CsI:Tl columnar crystals can be used that have an average thickness of about 300 to 500 μm, an average column diameter of 8 μm, and a Tl concentration of about 1.0 mol % as measured by inductively coupled plasma (ICP) emission spectroscopy. Examples of granular scintillators include gadolinium oxysulfide containing a slight amount of terbium (Tb) (i.e., Gd₂O₂S:Tb). The substrate 122 can be formed of a material with high radiation transmittance, such as amorphous carbon (a-C) or aluminum (Al). The reflective layer 123 reflects light emitted by the scintillator 121 toward the sensor panel 110. The reflective layer 123 can be formed of a material with high light (optical) reflectance and high radiation transmittance, such as silver (Ag) or Al. The reflective layer 123 can be omitted if the substrate 122 is formed of Al. The insulating layer 124 inhibits electrochemical corrosion between the substrate 122 and reflective layer 123 and the scintillator 121. The insulating layer 124 can be formed of an organic insulating material such as poly(p-xylylene) or an inorganic insulating material such as SiO₂. For example, if the substrate 122 is formed of Al, the insulating layer 124 can be formed of Al₂O₃. The covering layer 125 protects the scintillator 121 from, for example, humidity degradation. For CsI:Tl, which is highly hygroscopic, the covering layer 125 can be formed so as to cover the scintillator 121. Examples of materials used for the covering layer 125 include common organic sealing materials such as silicone resins, acrylic resins, epoxy resins, and fluoropolymer resins and hot-melt resins such as polyesters, polyolefins, and polyamides. In particular, the covering layer 125 can be formed of a resin with low moisture permeability. Examples of such resins include organic resins formed by chemical vapor deposition (CVD), such as poly(p-xylylene), and hot-melt resins such as polyolefins. An example of a hot-melt resin is a polyolefin hot-melt resin having a refractive index of 1.47 and applied to a thickness of 15 to 25 μm. An example of a fluoropolymer resin is FLUOROSURF FG-3020 (available from Fluoro Technology) applied to a thickness of 4 μm. This resin is a liquid resin transparent to visible light and having a refractive index of 1.35 and a viscosity of 400 cPs. In this embodiment, the surface of the scintillator panel 120 opposite the sensor panel 110, i.e., the surface of the covering layer 125 opposite the sensor panel 110, has a subwavelength structure 125a including extremely small protrusions and recesses.

As shown in FIGS. 3A and 3B, the subwavelength structure 125a includes protrusions 301. Each two adjacent protrusions 301 have a pitch P below the diffraction limit (P<λ/2n) for the wavelength of the light emitted by the scintillator 121. This structure is termed the subwavelength structure (SWS). The symbol λ is the wavelength of light, and the symbol n is the refractive index. The diffraction limit means that light cannot distinguish a structure smaller than the wavelength thereof because it behaves as a wave. At an interface between a plurality of members having different refractive indices, light can detect a structure having a period below the diffraction limit (<λ/2n) virtually only as the “average.” Consequently, light detects a gradual change in refractive index between a plurality of members having different refractive indices, meaning that there is no interface for light where the refractive index changes sharply. This reduces reflection between a plurality of members. If the pitch P of the protrusions 301 does not fall below the diffraction limit for the wavelength of the light emitted by the scintillator 121, light can form one wavelength within the protrusions 301. This allows the light to be reflected at the interface between the protrusions 301 and another object, thus decreasing the intensity of the light transmitted. Reflection between two members includes reflection of light from the member having a higher refractive index toward the member having a lower refractive index and reflection of light from the member having a lower refractive index toward the member having a higher refractive index. The subwavelength structure 125a formed on the surface of the scintillator panel 120 reduces a decrease in the availability of the light emitted by the scintillator panel 120 at the sensor panel 110 due to reflection on that surface. Thus, a scintillator panel and a radiation detection apparatus having high optical output and high resolution can be provided. In this embodiment, the protrusions 301 of the subwavelength structure 125a have a semi-oval shape with a pitch P of 200 nm and a height H of 300 nm. The protrusions 301, which are regularly arranged at a constant pitch P in this embodiment, can be arranged at an irregular pitch. In this case, the average pitch falls below the diffraction limit for the wavelength of the light emitted by the scintillator 121. That is, if the protrusions 301 are arranged at an irregular pitch, the pitch P is the average pitch. The pitch P is the distance between the centers of gravity of the protrusions 301.

For effective use of the light emitted by the scintillator 121, the wavelength λ can be the maximum emission wavelength. For more effective use of the light emitted by the scintillator 121, the wavelength λ can be the lowest emission wavelength. The maximum emission wavelength is the wavelength of the light emitted by the scintillator 121 with the highest intensity. The lowest emission wavelength is the shortest wavelength of the light emitted by the scintillator 121. For example, if the scintillator 121 is CsI:Tl, which has a maximum emission wavelength of 550 nm, a pitch P of less than 275 nm falls below the diffraction limit for the peak wavelength. If the scintillator 121 is GOS:Tb, which typically has a maximum emission wavelength of 520 to 580 nm, a pitch P of less than 260 nm falls below the diffraction limit for the maximum emission wavelength. The height H of the protrusions 301 is not limited, although it can be similar to the pitch P for simplicity of the manufacturing process. The lower limit of the pitch P is the manufacturing limit to which the subwavelength structure 125a can be formed, i.e., 40 nm or more, which is the exposure limit of semiconductor exposure apparatuses.

The sensor panel 110 includes a substrate 111, such as a glass substrate, having an insulating surface on which the pixels 112, which are arranged in a matrix, wiring lines 113, a passivation layer 114, and a protective layer 115 are disposed. The pixels 112 include the photoelectric conversion elements 202 and switching elements 201. The photoelectric conversion elements 202 are disposed above the switching elements 201 with an interlayer insulator 203 therebetween. Each photoelectric conversion element 202 has one electrode thereof connected to the corresponding switching element 201. In this embodiment, the photoelectric conversion elements 202 are photoelectric conversion elements formed by a thin-film semiconductor process, including metal-insulator-semiconductor (MIS) sensors and PIN photodiodes based on non-single-crystal semiconductor materials such as amorphous silicon. The switching elements 201 are disposed between the substrate 111 and the photoelectric conversion elements 202 and are connected to the photoelectric conversion elements 202 via contact holes provided in the interlayer insulator 203. In this embodiment, the switching elements 201 are thin-film semiconductor elements formed by a thin-film semiconductor process, including thin-film transistors based on non-single-crystal semiconductor materials such as amorphous silicon and polycrystalline silicon. The pixels 112 have a width of 50 to 200 μm. The pixels 112 are periodically arranged in a matrix at a pitch equal to the width thereof. The wiring lines 113 are connected to the pixels 112. The wiring lines 113 include drive lines for driving the pixels 112, signal lines for transmitting electrical signals generated by the pixels 112, and bias lines for supplying a bias to the photoelectric conversion elements 202. The passivation layer 114 covers the pixels 112 and the wiring lines 113. The passivation layer 114 is formed of an inorganic material with high transmittance to the light emitted by the scintillator 121, described later. Examples of inorganic materials include SiNₓ, SiO₂, TiO₂, LiF, Al₂O₃, and MgO. For example, the passivation layer 114 is a nitride silicon layer having a thickness of 0.5 μm and a refractive index of 1.90. The protective layer 115 covers at least the passivation layer 114 on the pixels 112. The protective layer 115 is formed of an organic resin with high transmittance to the light emitted by the scintillator 121. Examples of organic resins include polyphenylene sulfide resins, fluoropolymer resins, polyetheretherketone resins, polyethernitrile resins, polysulfone resins, polyethersulfone resins, polyarylate resins, polyamideimide resins, polyetherimide resins, polyimide resins, epoxy resins, and silicone resins. In this embodiment, the protective layer 115 is formed of a material with a different refractive index from the covering layer 125. For example, the protective layer 115 is a polyimide resin layer having a thickness of 7 μm and a refractive index of 1.70. In this embodiment, the surface of the sensor panel 110 opposite the scintillator panel 120, i.e., the surface of the protective layer 115, has a subwavelength structure 115a. The subwavelength structure 115a is similar to the subwavelength structure 125a. It should be noted that the subwavelength structure 115a is optional; the surface of the protective layer 115 can be smooth. Alternatively, a subwavelength structure can be formed on the surface of the passivation layer 114 opposite the scintillator 121 without providing the protective layer 115. In this case, for example, a subwavelength structure can be formed by etching through a dot resist pattern formed by photolithography using a semiconductor exposure apparatus.

In this embodiment, the scintillator panel 120 and the sensor panel 110 are bonded together with the sealing part 130, with a member 126 disposed therebetween. Whereas the member 126 is an air layer (whose refractive index is 1) having a thickness of 25 μm in this embodiment, it can instead be an adhesive having high light transmittance and a different refractive index from the covering layer 125. The use of an adhesive improves adhesion between the scintillator panel 120 and the sensor panel 110. For high resolution, on the other hand, an air layer can be used because if an adhesive is used, its thickness adds to the distance between the photoelectric conversion elements 202 and the scintillator 121 and might therefore decrease the resolution. The adhesive can be a material that is so soft and conformable to the surface profile that a subwavelength structure can be transferred. For example, the adhesive can be a material that is liquid when applied and that can be solidified by thermal curing treatment after stacking. Examples of such materials include low-viscosity silicone resins, fluoropolymer resins, acrylic resins, and epoxy resins. An example of an acrylic resin is an acrylic adhesive having a refractive index of 1.55 and applied to a thickness of 25 μm. An example of a fluoropolymer resin adhesive is FLUOROSURF FG-3020 (available from Fluoro Technology). This resin is a liquid resin transparent to visible light and having a refractive index of 1.35 and a viscosity of 400 cPs. Alternatively, the sensor panel 110 and the scintillator panel 120 may be bonded together without the member 126 therebetween. In this case, specifically, the covering layer 125 is formed by applying a liquid resin to the surface of the scintillator 121 and stacking it on the sensor panel 110 before the liquid resin cures. As a result, the subwavelength structure of the protective layer 115 is transferred to the surface of the covering layer 125. The liquid resin is then cured to form the covering layer 125.

For improved moisture resistance of the scintillator panel 120, the sealing part 130 can be formed of a material with low moisture permeability, such as an epoxy resin or an acrylic resin, as is the covering layer 125.

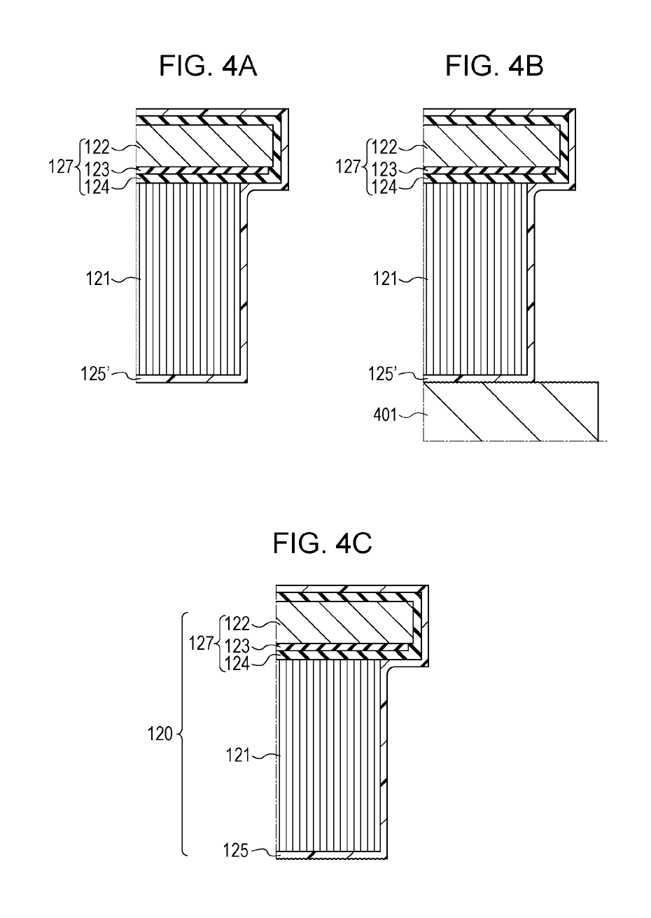

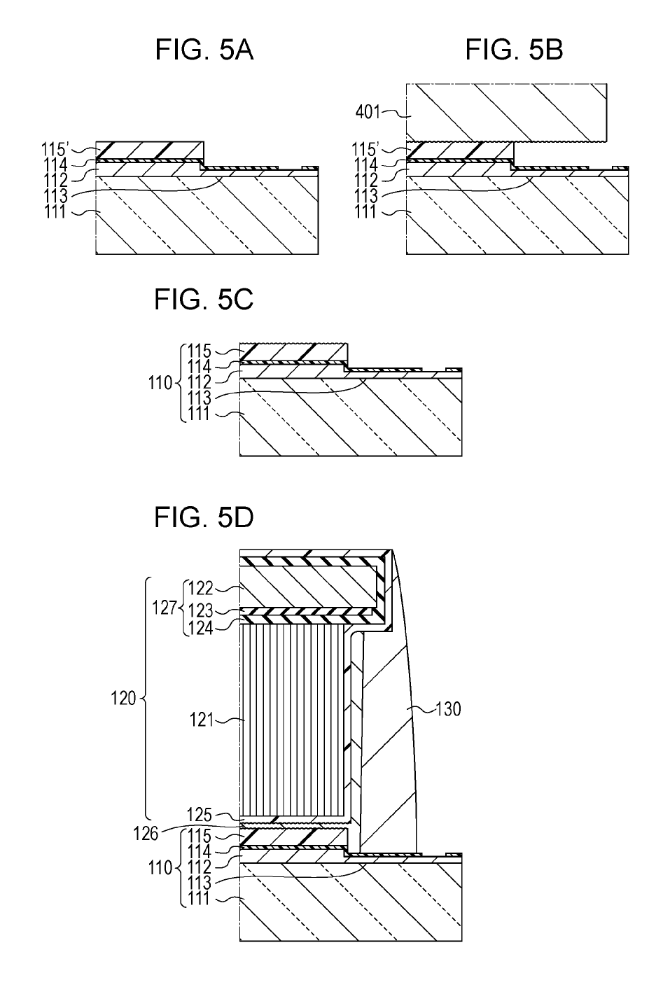

Next, an example of a method for manufacturing a radiation detection apparatus according to an embodiment of the present invention will be described with reference to FIGS. 4A to 4C and 5A to 5D. FIGS. 4A to 4C are sectional views illustrating a process of manufacturing a scintillator panel according to this embodiment. FIGS. 5A to 5D are sectional views illustrating a process of manufacturing a sensor panel and a radiation detection apparatus according to this embodiment.

The process of manufacturing a scintillator panel according to this embodiment will now be described with reference to FIGS. 4A to 4C. As shown in FIG. 4A, a layer 125′ is formed so as to cover the scintillator 121 formed on the insulating layer 124 of the support 127, which includes the substrate 122, the reflective layer 123, and the insulating layer 124. As shown in FIG. 4B, a mold 401 having a subwavelength structure on a surface thereof is pressed against the surface of the layer 125′ opposite the scintillator 121. As shown in FIG. 4C, the mold 401 is removed from the surface of the layer 125′ to form the covering layer 125, which has the subwavelength structure 125a on the surface thereof opposite the scintillator 121. Thus, the scintillator panel 120 is provided, which has the subwavelength structure 125a on the surface thereof.

Next, the process of manufacturing a sensor panel and a radiation detection apparatus according to this embodiment will be described with reference to FIGS. 5A to 5D. As shown in FIG. 5A, an inorganic insulating film is formed so as to cover the pixels 112 and the wiring lines 113 formed on the substrate 111 by a known semiconductor fabrication technique, and openings are formed at appropriate positions in the inorganic insulating film to form the passivation layer 114. A layer 115′ is then formed on the passivation layer 114. As shown in FIG. 5B, the mold 401, which has a subwavelength structure on a surface thereof, is pressed against the surface of the layer 115′. As shown in FIG. 5C, the mold 401 is removed from the surface of the layer 115′ to form the protective layer 115, which has the subwavelength structure 115a on the surface thereof. Thus, the sensor panel 110 is provided, which has the subwavelength structure 115a on the surface thereof. The sensor panel 110 and the scintillator panel 120 are then bonded together with the sealing part 130 such that the subwavelength structure 125a faces the subwavelength structure 115a and the pixels 112 with the member 126 therebetween. Finally, the circuit boards such as the signal-processing flexible circuit boards 152 are mounted on the sensor panel 110 so as to be connected to the wiring lines 113 via connection parts 154, such as anisotropic conductive members, in the openings of the passivation layer 114. Thus, the radiation detection apparatus shown in FIGS. 1A and 1B is provided.

Although this embodiment uses a sensor panel including photoelectric conversion elements and switching elements formed by a thin-film semiconductor process, the present invention is not limited thereto. For example, sensor panels including photoelectric conversion elements based on single-crystal semiconductor materials such as single-crystal silicon, including active pixel sensors and charge-coupled device (CCD) sensors, can be used. Instead of using the mold 401, a subwavelength structure can be formed by dry etching through a dot resist pattern formed by photolithography using a semiconductor exposure apparatus. Although the subwavelength structure 125a is formed on the surface of the covering layer 125, the present invention is not limited thereto. For example, the subwavelength structure 125a can be formed on the surface of the scintillator panel 120 opposite the sensor panel 110 without forming the covering layer 125. That is, the subwavelength structure 125a can be formed on any surface opposite the sensor panel 110. In particular, this structure can be selected for granular scintillators, which have high moisture resistance. For granular scintillators, which scatter more light than columnar crystal scintillators, reducing the distance between the scintillator 121 and the sensor panel 110 by eliminating the covering layer 125 is more effective in terms of sharpness.

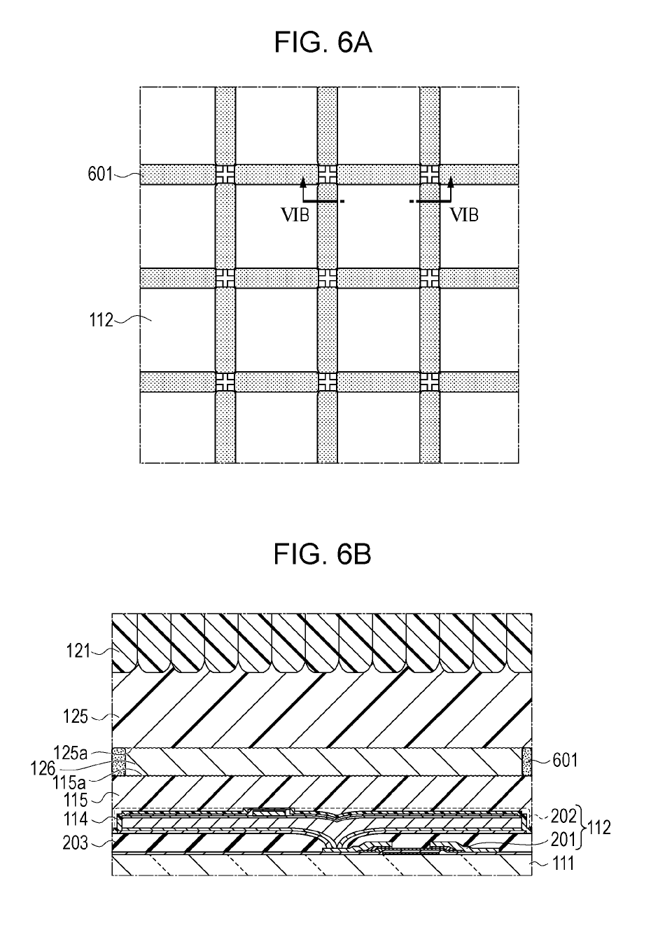

As shown in FIGS. 6A and 6B, a light-absorbing member 601 having a grid function can be provided between the sensor panel 110 and the scintillator panel 120. FIG. 6A is a schematic plan view illustrating a radiation detection apparatus according to another embodiment. FIG. 6B is a sectional view taken along line VIB-VIB in FIG. 6A. The light-absorbing member 601 is disposed between the sensor panel 110 and the scintillator panel 120 such that an orthogonal projection thereof is located in at least a portion of the region between the pixels 112. The light-absorbing member 601 is formed of a material capable of absorbing the light emitted by the scintillator 121, for example, a resin containing a black pigment. The member 601 can have adhesive properties. Examples of such resins include adhesive resins such as silicone resins, epoxy resins, and acrylic resins. The member 601 needs to be formed by a process such as dispensing, inkjet printing, or screen printing for high alignment accuracy between the pixels 112. This requires the resin to have relatively low viscosity, preferably 100 Pa·s or less, more preferably 50 Pa·s or less. The member 601 can have a spacer function to reliably define the distance between the sensor panel 110 and the scintillator panel 120. For example, the member 601 can have a width of 40 μm and a height of 5 μm and be formed of a black epoxy resin such as AE-901T-DA (available from Ajinomoto Fine-Techno Co., Inc.).

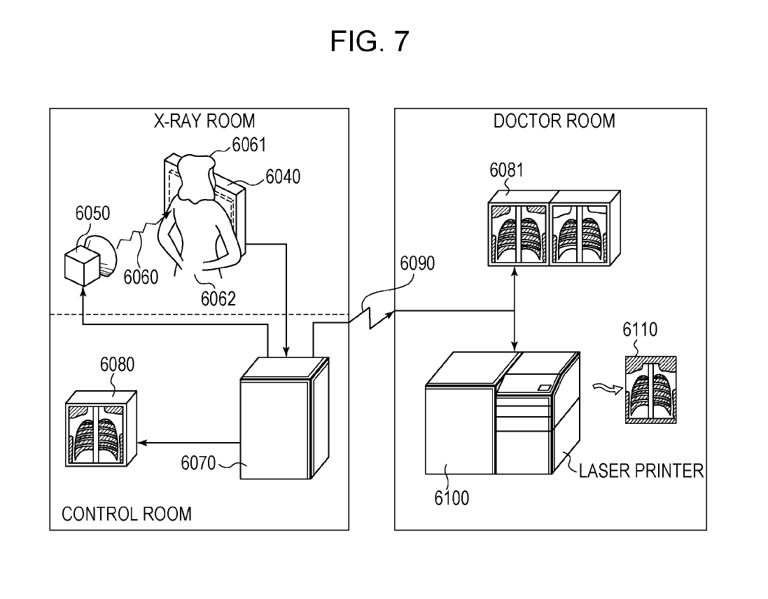

Next, an example of a radiation detection system including a radiation detection apparatus according to an embodiment of the present invention will be described with reference to FIG. 7.

An X-ray tube 6050, which corresponds to a radiation source, emits an X-ray 6060. The X-ray 6060 passes through a chest 6062 of a patient or subject 6061 and is incident on conversion elements of a conversion unit included in a radiation detection apparatus 6040 according to this embodiment. The incident X-ray contains information about the body of the patient 6061. The conversion unit converts the incident X-ray into electrical charge, thereby acquiring electrical information. This information is converted into digital data, is processed by an image processor 6070, which corresponds to a signal-processing unit, and can be displayed on a display 6080, which corresponds to a display unit, in a control room.

This information can also be transferred to a remote place via a transmission processing unit such as a telephone line 6090, can be displayed on a display 6081, which corresponds to a display unit, or recorded on a recording unit such as an optical disk in a doctor room at the remote place, and can be used therein for diagnosis by a doctor. The information can also be recorded on a recording film 6110, which corresponds to a recording medium, by a recording film processor 6100, which corresponds to a recording unit.

A radiation detection apparatus according to an embodiment of the present invention can be evaluated for the amount of light received and sharpness using image signals generated by the radiation detection apparatus by the following methods. The results demonstrate that the radiation detection apparatus according to this embodiment has a larger amount of light received and a higher sharpness than a radiation detection apparatus including a covering layer having no subwavelength structure on the surface thereof.

The method for evaluating the amount of light received will now be described. The radiation detection apparatus is set on testing equipment. An Al filter having a pitch of 20 mm for removing soft X rays is set between an X-ray source, which corresponds to a radiation source, and the radiation detection apparatus. The distance between the radiation detection apparatus and the X-ray source is adjusted to 130 cm. In this state, the radiation detection apparatus is irradiated with a pulsed X-ray having a pulse widt of 50 ms at an X-ray tube voltage of 80 kV and an X-ray tube current of 250 mA to acquire an image. The amount of light received is determined from the image output value in the center of X-ray irradiation.

Next, the method for evaluating modulation transfer function (MTF), which is a measure of sharpness, will be described. The radiation detection apparatus is set on testing equipment. An Al filter having a pitch of 20 mm for removing soft X rays is set between an X-ray source, which corresponds to a radiation source, and the radiation detection apparatus. The distance between the radiation detection apparatus and the X-ray source is adjusted to 130 cm. A tungsten MTF chart is set at a measurement site. The MTF used herein has 2 LP/mm. In this state, the radiation detection apparatus is irradiated with a pulsed X-ray having a pulse width of 50 ms at an X-ray tube voltage of 80 kV and an X-ray tube current of 250 mA to acquire a chart image. The radiation detection apparatus is also irradiated under the same conditions without the MTF chart to acquire an image. These images are analyzed to determine the MTF.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-283301 filed Dec. 26, 2011, which is hereby incorporated by reference herein in its entirety.

What is claimed is:

1. A scintillator panel comprising:
a scintillator that converts radiation into light of a wavelength detectable by photoelectric conversion elements,
wherein the scintillator panel has a surface including a plurality of protrusions adjacent to each other, and
wherein the adjacent protrusions are arranged at a pitch below a diffraction limit for the wavelength of the light emitted by the scintillator.

2. The scintillator panel according to claim 1, further comprising a covering layer covering the scintillator,
wherein the surface is a surface of the covering layer, and
wherein, when the pitch is defined by P, the pitch satisfies 40 nm≦P<λ/2n,
where X is the wavelength of light emitted by the scintillator and n is the refractive index of adjacent protrusions.

3. The scintillator panel according to claim 2, wherein the scintillator is a columnar crystal alkali halide scintillator.

4. The scintillator panel according to claim 1, wherein the scintillator is a granular scintillator, and
wherein the surface is a surface of the scintillator.

5. The scintillator panel according to claim 1, wherein the pitch falls below a diffraction limit for a maximum emission wavelength, the maximum emission wavelength being a wavelength of the light emitted by the scintillator with the highest intensity.

6. The scintillator panel according to claim 1, wherein the pitch falls below a diffraction limit for a lowest emission wavelength, the lowest emission wavelength being the shortest wavelength of the light emitted by the scintillator.

7. A radiation detection apparatus comprising:
a sensor panel including photoelectric conversion elements;
a scintillator panel including a scintillator that converts radiation into light of a wavelength detectable by the photoelectric conversion elements; and
a member having a different refractive index from a surface of the scintillator panel opposite the sensor panel, the scintillator being disposed on the sensor panel with the member between the surface and the photoelectric conversion elements,
wherein the surface includes a plurality of protrusions adjacent to each other, and
wherein the adjacent protrusions are arranged at a pitch below a diffraction limit for the wavelength of the light emitted by the scintillator.

8. The radiation detection apparatus according to claim 7, wherein the sensor panel includes a plurality of pixels arranged in a matrix, the pixels including the photoelectric conversion elements,
wherein the member includes a light-absorbing member that absorbs the light emitted by the scintillator, and
wherein the light-absorbing member is disposed between the sensor panel and the scintillator panel such that an orthogonal projection of the light-absorbing member is located in at least a portion of a region between the pixels.

9. The radiation detection apparatus according to claim 7, wherein the member comprises air.

10. The radiation detection apparatus according to claim 7, wherein the scintillator panel further includes a covering layer covering the scintillator,
wherein the surface is a surface of the covering layer opposite the sensor panel, and
wherein the pitch is 40 nm or more.

11. The radiation detection apparatus according to claim 7, wherein the surface is a surface of the scintillator opposite the sensor panel.

12. A radiation detection system comprising:
the radiation detection apparatus according to claim 7;
a signal-processing unit configured to process a signal from the detection apparatus;
a recording unit configured to record the signal from the signal-processing unit;
a display unit configured to display the signal from the signal-processing unit; and
a transmission processing unit configured to transmit the signal from the signal-processing unit.
